(19) United States
(12) Patent Application Publication
(10) Pub. No.: US 2016/0007530 A1
(43) Pub. Date: Jan. 14, 2016

(54) STALK SHREDDER FOR A CORN HARVESTING DEVICE

(71) Applicant: DEERE & COMPANY, MOLINE, IL (US)

(72) Inventors: KLAUS AWATER, REES-HALDERN (DE); DIRK BONGERT, STADLOHN (DE)

(21) Appl. No.: 14/703,427

(22) Filed: May 4, 2015

(30) Foreign Application Priority Data
Jul. 10, 2014 (DE) 102014213419.6

(51) Int. Cl. A01D 34/835; A01D 34/73; A01D 45/02

(52) U.S. Cl. CPC A01D 34/8355; A01D 45/02; A01D 34/73

(57) ABSTRACT

A stalk shredder (132) configured to be attached beneath a row unit (152) of a corn harvesting device (108) comprises a first blade (134) and a second blade (136), which are placed or affixed beneath the row unit (152) of the corn harvesting device (108) and which can be made to rotate around at least essentially vertical rotational axes. The enveloping circles of the blades (134, 136) overlap beneath a plant stalk delivery area (154) of the row unit (152) of the corn harvesting device (108). The blades (134, 136) impact, from various directions, on plant stalks that are delivered downward from the row unit (152).

The invention under consideration refers to a stalk shredder for attachment below a row unit of a corn harvesting device, wherein the stalk shredder comprises a first blade and a second blade, which can be placed or affixed below the row unit of the corn harvesting device and can be made to rotate around at least essentially vertical axes of rotation, and the enveloping circles of the blades overlap below a plant stalk delivery area of the row unit of the corn harvesting device.

### BACKGROUND OF THE INVENTION

In harvesting corn with a picker that has row units, in which the plants are pulled downward during the harvesting by means of picking rolls, and the corncobs are stripped off the stalks and subsequently are transported to a harvesting machine by conveyance means for a further processing, the plant stalks are successively expelled downward by the picking rolls. To the extent that the stalks are not cut up by blades of the picking rolls, stalk shredders are usually provided for the chopping of plant stalks remaining as shredded material on the field; they comprise a single two-arm blade, driven so that it rotates around an at least somewhat vertically oriented axle (DE 10 2004 008 342 A1). What can be regarded as disadvantageous is that in all cases, the stalks are not cut up sufficiently small by the single blade. Furthermore, the shredded material is expelled in only one direction, which leads to the formation of strips of plant residue on the field and thus complicates or prevents a uniform working into the soil.

In the generically regarded DE 20 05 352 C, it was proposed that cutting rolls that are arranged in pairs and comb together be affixed below a corn picker; on the rear end, these rolls extend at an incline to the rear and downward. Here, the cutting essentially takes place along the length of the plant, which produces very long shredded material that rots with difficulty, which is also deposited in strips.

Finally, DE 10 2004 020 447 A1 proposed the affixing of a stalk shredder for the cutting up of the stubble remaining on the field, in conjunction with a mowing attachment used with the field chopper for the harvesting of whole plants; it comprises several blades, arranged coaxially above one another, which rotate in the same direction. Here, the stubble is cut several times by the blades located above one another, but here too, the disadvantage of the formation of strips appears.

The goal of the invention under consideration is to make available an improved stalk shredder, which does not have the aforementioned disadvantages or has them to a reduced extent.

### SUMMARY OF THE INVENTION

In accordance with one aspect of the invention, a stalk shredder for a row unit of a corn harvesting device comprises at least two blades, which can be affixed or placed below the plant stalk delivery area of the row unit of the corn harvesting device and are made to rotate around an at least essentially vertical axis of rotation. The enveloping circles of the blades overlap below the plant stalk delivery area of the row unit of the corn harvesting device, and the blades act, from different directions, on plant stalks, delivered from the row unit downward.

The first blade impacts, in a first direction (for example, from the front) on the plant stalks, delivered from the row unit downward, whereas the second blade impacts, from a second opposite direction (for example, from behind) on the plant stalks delivered from the row unit downward. The cut plant parts are therefore cut, and are also delivered onto the field, in different directions. Thus, an improvement in the cutting quality is attained, since the stalks are cut up by two blades from different directions, and because of the different cutting and thus delivery directions, the formation of strips to be observed in the state of the art is avoided.

In accordance with another aspect of the invention, the second blade is made to rotate around an axis of rotation that is coaxial to the axis of rotation of the first blade, contrary to the direction of the second blade, and is located below the first blade. The two blades are thus located coaxially above one another and rotate in opposite directions. In this embodiment, the blades can be driven by means of a gear that is a component of a drive of the corn harvesting device or is separate from it and is in a drive connection with the second blade by means of a shaft, whereas it is in a drive connection with the first blade by means of a hollow shaft, within which the shaft extends. The gear is set up so as to drive the shaft and the hollow shaft in opposite rotation directions

In accordance with another aspect of the invention, the blades are located on different sides of the plant stalk delivery area of the row unit of the corn harvesting device and are staggered in height relative to one another, or are angularly staggered, and can be driven in the same direction.

The stalk shredder can be used on a corn harvesting device in the form of a corn picker for a combine harvester to cut up the plant stalks delivered downward by the picker, so as to cut up, on the spot, the stubble remaining on the field. It can also be used with a field chopper on a corn harvesting device as a mowing attachment for the whole plant harvest, equipped with row units in the form of mowing and collecting drums.

### DETAILED DESCRIPTION OF THE PREFERRED EMBODIMENTS

The figures show three embodiments of the invention, wherein the reference symbols may not be used for a limiting interpretation of the patent claims:

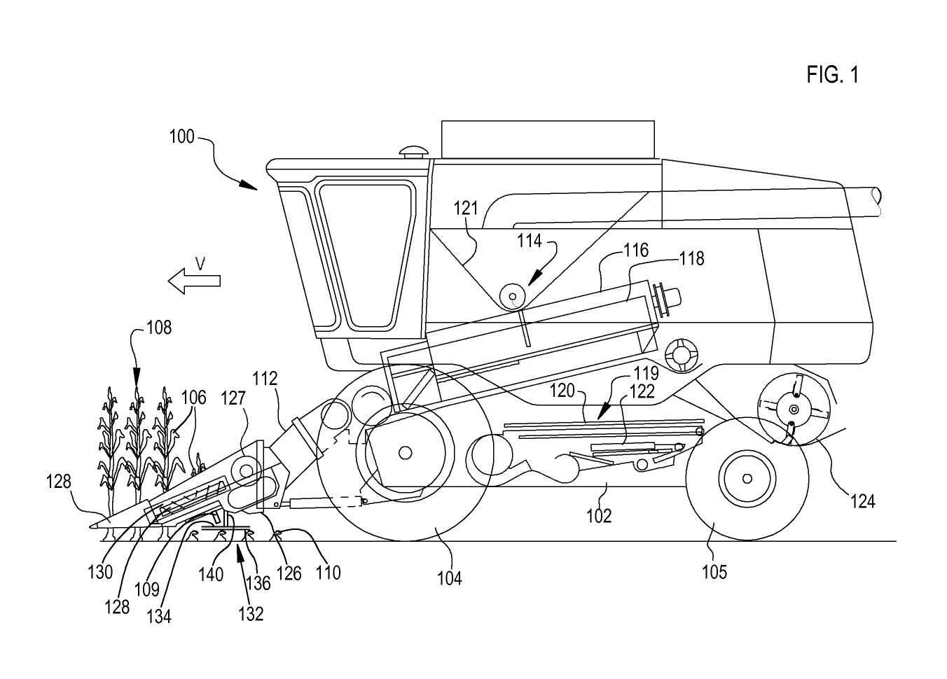

FIG. 1 shows a side view of a self-propelling harvesting machine with a corn harvesting device in the form of a corn picker, on whose lower side a stalk shredder in accordance with the invention has been placed;

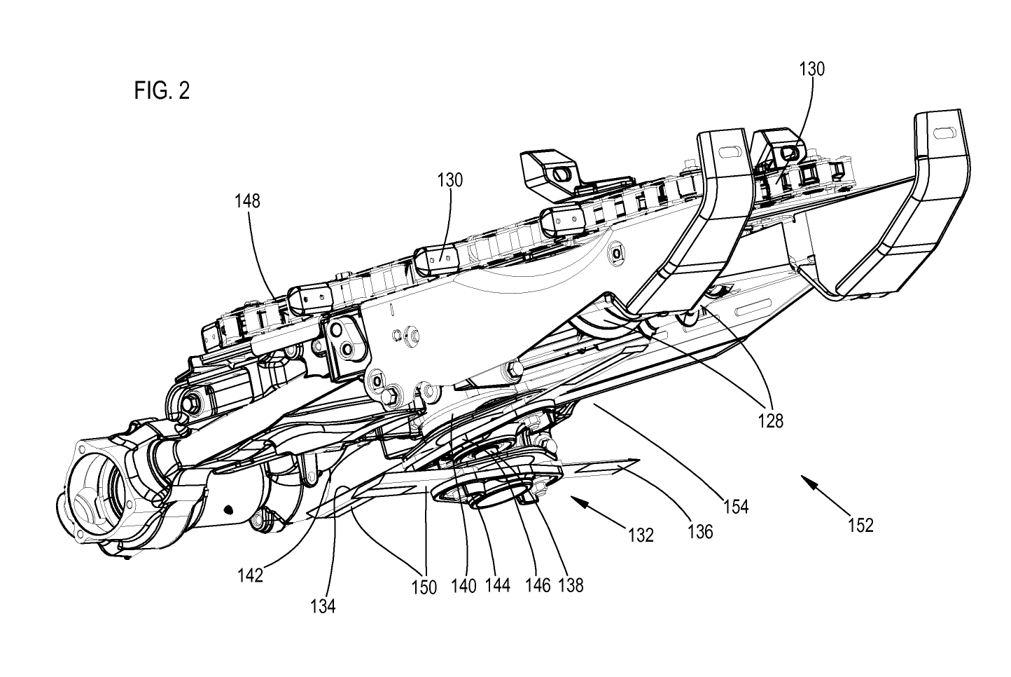

FIG. 2 a perspective view of a row unit of the corn picker with a first embodiment of the stalk shredder;

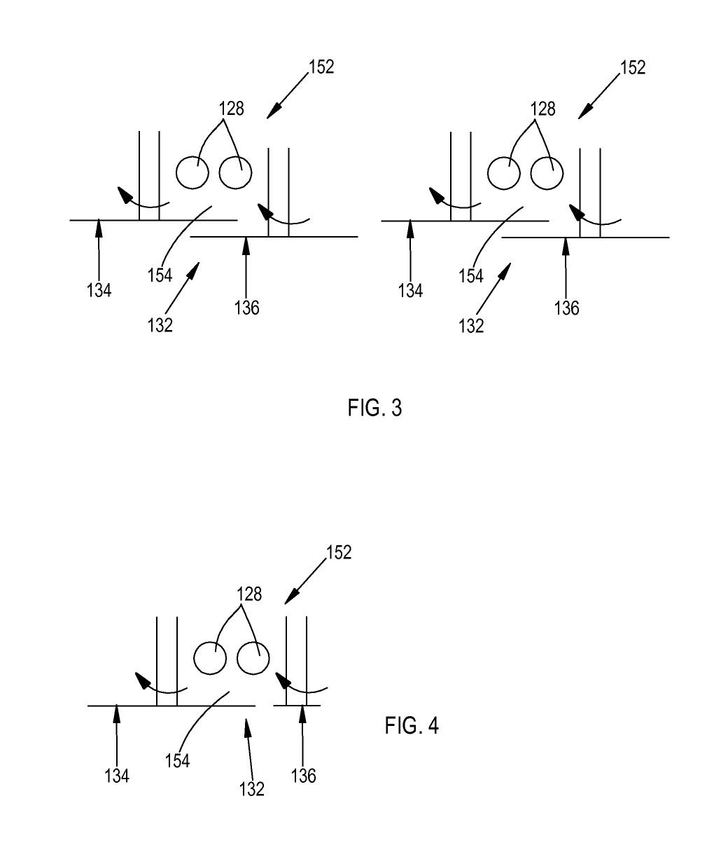

FIG. 3 two row units of a corn picker with stalk shredders arranged underneath, according to a second embodiment; and

FIG. 4 a row unit of a corn picker with a stalk shredder arranged underneath, according to a third embodiment.

FIG. 1 shows a self-propelling harvesting machine 100 in the form of a combine harvester. The harvesting machine 100 comprises a travelling frame 102, supported on front drive wheels 104 and back steerable wheels 105, on whose front side there is a collecting conveyor 112, which, during operation, supplies crops taken up by a corn harvesting device 108, affixed in a detachable manner on its front side, to a threshing and separating device, which is made up here of an axial rotor 118 and a housing 116. Threshed grains are cleaned in a cleaning part 119 with an upper screen 120 and a lower screen 122 and then sent on to a grain tank 121, from which they can be transferred by means of a conveyor 114 to a transport vehicle. Crop remains expelled on the back side of the threshing and separating device are cut up by means of a straw shredder 124 and distributed on the field.

The corn harvesting device 108 comprises a frame 126, which comprises a number of row units 152 for the picking of corn plants 106 that are arranged laterally next to one another; divider tips 128 are arranged between them. The row units 152 comprise two picking rolls 128, which pull the stalks 109 of the corn plants 106 downward between them, and chain conveyors 130, arranged above, which convey the cobs separated from the stalks on stripping surfaces backward, where they are supplied to the collecting conveyor 112 above a transverse conveyor screw 127.

Below the picking rolls 128, successive plant stalks 109 are delivered downward in a plant stalk delivery area 154 and cut up by means of a stalk shredder 132. The stalk shredder 132 comprises a first blade (upper blade 134) and a second blade 136 arranged coaxially underneath the upper blade 134.

The blades 134, 136 rotate in opposite directions around approximately vertical axles and are driven by a gear 142 (see FIG. 2). The second blade 136 is driven by means of a shaft 138, which extends through a hollow shaft 140, which is used to drive the first blade 134. The rotational speed of the two blades 134, 136 can be the same or different.

FIG. 2 shows a perspective view of a row unit 152. The gear 142 is integrated into the drive of the picking rolls 128 and chain conveyor 130, although it can also be designed separately from it and thus refitted in another embodiment. The shaft 138 drives a middle holder 144, on which two [sic; beaters 150], which are flat and equipped with cutting edges and used as the first blade 134, are suspended, swinging freely around an axle running parallel to the rotational axis of the shaft 138. The hollow shaft 140 also drives a middle holder 146, on which two beaters 150, provided with cutting edges and used as the first blade 134, are suspended, freely swinging around an axis running parallel to the rotational axis of the hollow shaft 140. By means of a switch lever, it is possible to switch off the gear 142 and thus the drive of the blades 134, 136. In another embodiment, the blades 134 and/or 136 can also comprise a smaller or larger number of beaters 150 than shown, or the latter could also be affixed rigidly on the holders 144 or 146.

With a contrary rotating direction of the blades 134, 136, one attains an improved result during the shredding of the plant stalks 109 and avoids the formation of strips that is observed with individual blades in the state of the art. The blades 134 and, in particular, 136, moreover, also cut the plant stubble 110 that remains in the soil very short.

In the embodiment according to FIG. 3, the blades 134, 136 are located on different sides of the picking rolls 128 (and thus, the picking gap). They rotate in the same direction and are staggered with respect to height. In the embodiment according to FIG. 4, the blades 134, 136 are not staggered with respect to height, but rather are situated at different (synchronized) rotation angles. They also find themselves in the same direction. One could also combine the embodiments according to FIGS. 3 and 4, that is, one could place the blades 134, 136 staggered with respect to height and angularly.

In the embodiments according to FIGS. 3 and 4, the blades 134, 136, as in the first embodiment, impact the plant stalks 109 in different (contrary) directions, so that the cutting effect is improved and the formation of strips is avoided.

The above illustrations and corresponding description are provided to illustrate several different ways to make the invention. The invention, however, is not limited to the illustrations and description above. The claims define the invention.

1. A stalk shredder (132) for attachment beneath a row unit (152) of a corn harvesting device (108), wherein the stalk shredder (132) comprises a first blade (134) and a second blade (136), which are placed or affixed beneath the row unit (152) of the corn harvesting device (108) and can be made to rotate around at least essentially vertical rotational axes and enveloping circles of the first blade (134) and the second blade (136) overlap beneath a plant stalk delivery area (154) of the row unit (152) of the corn harvesting device (108), characterized in that the first blade (134) and the second blade (136) impact, from different directions, on the plant stalks delivered from the row unit (152) downward.

2. The stalk shredder (132) according to claim 1, wherein the second blade (136) can be made to rotate around a rotational axis coaxial to the rotational axis of the first blade (134), in a direction contrary to the first blade (134), and is situated below the first blade (134).

3. The stalk shredder (132) according to claim 2, wherein the first blade (134) and the second blade (136) can be driven by means of a gear (142), which is a component of a drive of the corn harvesting device (108) or separate therefrom and is in a drive connection with the second blade (136) by means of a shaft (138) and is in a drive connection with the first blade (134) by means of a hollow shaft (140), within which the shaft (138) extends, wherein the gear (142) is set up to drive the shaft (138) and the hollow shaft (140) in opposing rotation directions.

4. The stalk shredder (132) according to claim 1, wherein the first blade (134) and the second blade (136) are situated on different sides of the plant stalk delivery area (154) of the row unit (152) of the corn harvesting device (108) and they are staggered, relative to one another, with respect to height or angular orientation and can be driven in the same direction.

5. The stalk shredder (132) according to claim 1, wherein the first blade (134) and the second blade (136) comprise a middle holder (144) with beaters with cutting edges, which are in fact flat and are suspended thereon in a swinging manner.

6. A corn harvesting device (108) comprising:
a corn picker; and
a stalk shredder (132) according to claim 1 affixed thereto.
